(19) United States
(12) Patent Application Publication
(10) Pub. No.: US 2016/0012198 A1
(43) Pub. Date: Jan. 14, 2016

(54) Medical Telecommunications System

(71) Applicant: VTM, LLC, Nashville, TN (US)

(72) Inventors: Albert F GAINER, III, Nashville, TN (US); Paul VAN HOESEN, Nashville, TN (US); Janice L BRAMLET, Nashville, TN (US); W Bruce CAMPBELL, Nashville, TN (US)

(21) Appl. No.: 14/773,174

(22) PCT Filed: Mar. 5, 2014
(86) PCT No.: PCT/US2014/020859

§ 371 Date: Sep. 4, 2015

Related U.S. Application Data
(60) Provisional application No. 61/772,862, filed on Mar. 5, 2013.

(51) Int. Cl. G06F 19/00; H04N 7/15

(52) U.S. Cl. CPC G06F 19/3418; H04N 7/15; G06F 19/3425

(57) ABSTRACT

A method and system for providing important medical information to patients via videoconference is provided, which further allows the videoconference to be recorded for later reference, and allow input from the patient to be recorded. The videoconference allows the patient to freely ask questions or seek further information. A user interface may be present to allow the patient to read text, see graphic illustrations, obtain printed matter, and respond non-verbally to the interviewer. The input and output of the user interface may also be recorded for future reference.

### BACKGROUND

In any effective healthcare system the patient is a critical participant in the patient's own care. If the patient is to participate in the patient's own care, then the patient must receive and understand all pertinent information pertaining to the care. This has become a serious challenge in the modern healthcare setting.

Multiple studies have shown that the medical system in the U.S. has increased time pressure within the doctor's practice. This pressure is directly impacting the ability of doctors to communicate consistent information to their patients about their condition, treatment plan, alternatives, and risks. In a study that taped 34 physicians during more than 300 visits with patients, it was reported that the doctors spent on average 1.3 minutes conveying crucial information about the patient's condition and treatment, and most of the information they provided was far too technical for the average patient to grasp; disconcertingly, those same doctors thought they had spent more than eight minutes. A method to increase the interactive, face-to-face time a patient has to absorb and discuss complex modern medical recommendations, and have critical questions answered by the physician is urgently needed.

When information is provided by a healthcare provider to a patient, it is generally done orally, during a brief appointment. Some doctors supplement this discussion with various written or web-based materials. Written and oral information have several serious limitations. Oral and written information might not be available for the patient's later review. Although a patient has the opportunity to ask questions and request clarification during an oral interview, the patient has no way of going back to review the oral discussion later. Although written materials or web-based materials may be accessed by a patient for later review, if a patient has questions about this information after leaving the healthcare provider's facility it is difficult to obtain answers. There is also no interactive discussion of the patient's understanding while they are watching or reading the materials. This is a significant challenge in every medical practice where pre-operative and post-operative information needs to be communicated.

Many patients rely on homecare providers, friends, and relatives to assist them with their care. Although written materials can be shared with such assistants, the assistant will not have the benefit of any oral information that the patient might have received. The patient's assistant may also have questions or need clarification that cannot be addressed by the written or pre-recorded materials.

Healthcare providers must be certain that the patient understands the information provided. Misunderstanding is to some degree unavoidable, due to several sources. Some patients may receive information in a language other than their first language. In some cases a nurse or doctor providing the information may unintentionally misspeak. The patient may simply become distracted for a moment and fail to hear what was said.

From the perspective of the healthcare provider, studies have shown that medical providers and their staff are unable to consistently ensure the patient understands the information as they are receiving it and all their concerns are addressed. As a result, if the patient suffers a negative outcome as a result of failing to understand medical information that was provided, it is impossible to determine whether there was some defect in the information when it was provided, the patient misunderstood the information, or the patient simply forgot the information. Consequently, such determinations must often be made after costly investigations or during litigation.

Needless to say, there is a serious need in the art for an interactive method to deliver medical information in a way that has one or more of the following beneficial attributes: minimizes the time demands on more highly trained medical professionals, notifies and updates the healthcare provider of the status of the interview, allows direct observation of the patient as the patient receives the information, allows the patient to ask questions at will, provides the comfort of interpersonal interaction to the patient during the process, provides consistent and thorough content, provides the time and opportunity for the patient to ask questions, documents to the physician that the patient has received this information, informs the physician of any unanswered patient questions, provides a way to review the information away from the healthcare provider's office, provides the information in a form which can be shared by the patient with others, provides such information to the patient in a way that can be reviewed later by the healthcare provider, reduces clinical wait times for patients, allows the healthcare provider to confirm the interactive delivery of medical information to the patient, and allows the healthcare provider to confirm whether the patient has reviewed the material away from the office. There is also a need for a method of confirming the information the patient received, and confirming the degree to which the patient understood the information.

### SUMMARY

This simplified summary provides a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

The needs described above, as well as others, are addressed by various embodiments of the methods, systems, and devices provided in this disclosure; although it is to be understood that not every embodiment disclosed will address a given need.

The invention provided herein involves the use of videoconferencing technology and digital recording to create a record of a videoconference in which the patient is provided with information about his or her care (an “intervention”), allowing the videoconference to be reviewed later.

One general embodiment disclosed is process for providing medical information pertaining to a medical intervention to a patient and documenting comprehension of the information by the patient, the process comprising: establishing a videoconference between the patient and a medical interviewer; providing a script to the medical interviewer based on the medical intervention; transmitting at least a portion of the script to the patient via the videoconference; transmitting a question to the patient via the videoconference to assess the patient's comprehension; and creating a machine-readable recording of the patient's response to the question.

Another general embodiment disclosed is a system for providing medical information pertaining to a medical intervention to a patient and ensuring comprehension of the information by the patient, the system comprising: a patient videoconference terminal; a interviewer videoconference terminal connected to the patient videoconference terminal via a data connection capable of conveying audiovisual data; an audiovisual recording device configured to record a videoconference between the patient terminal and the interviewer terminal; a record server 600 comprising a health record of the patient; and a script server comprising a plurality of scripts or script segments.

Another general embodiment disclosed is a system for providing medical information pertaining to a medical intervention to a patient and ensuring comprehension of the information by the patient, the process comprising: a means for two-way audiovisual communication between the patient and a medical interviewer; a means for digitally storing a plurality of script segments each corresponding to an intervention; a means for accessing the script segments by the interviewer; a means for accessing the patient's electronic medical record by the interviewer; a means for recording the two-way audiovisual communication between the patient and the interviewer; and a means for storing the two-way audiovisual communication between the patient and the interviewer.

Another general aspect of the invention is a memory storage device containing a program which, when read by a general purpose computer, causes the general purpose computer to execute any of the processes disclosed herein.

### BRIEF DESCRIPTION OF THE DRAWINGS

FIG. 1: A schematic illustration of a general embodiment of the system disclosed herein.

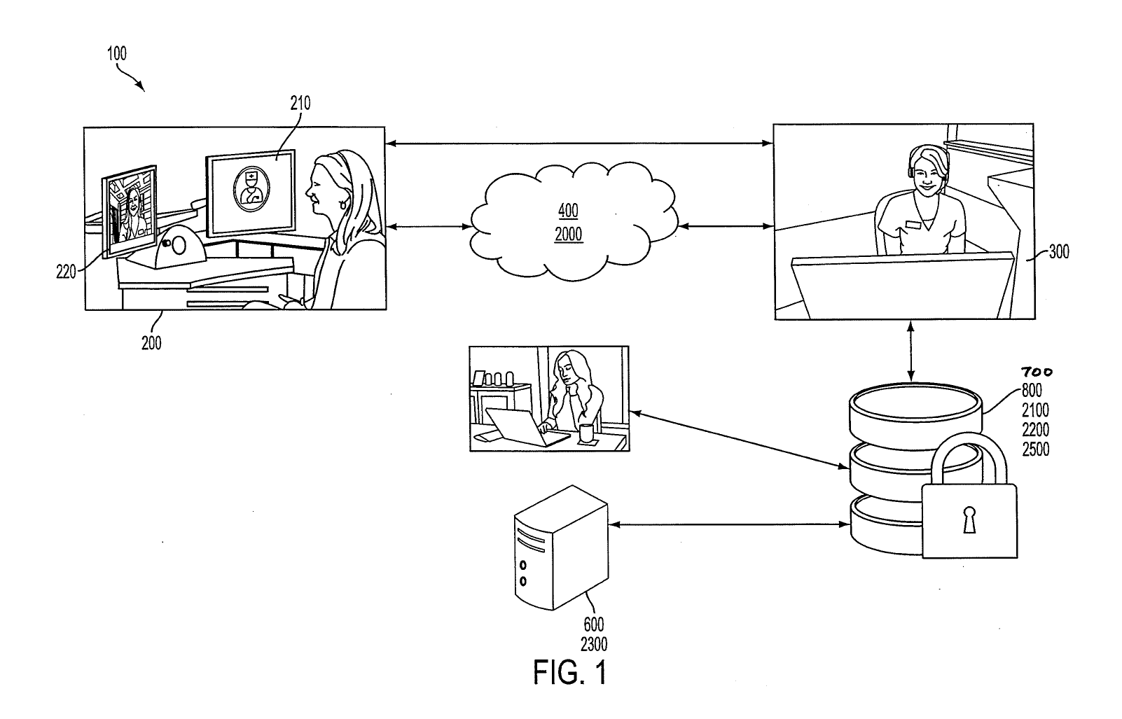

FIG. 2: Cutaway view of an embodiment of the interviewer videoconference terminal.

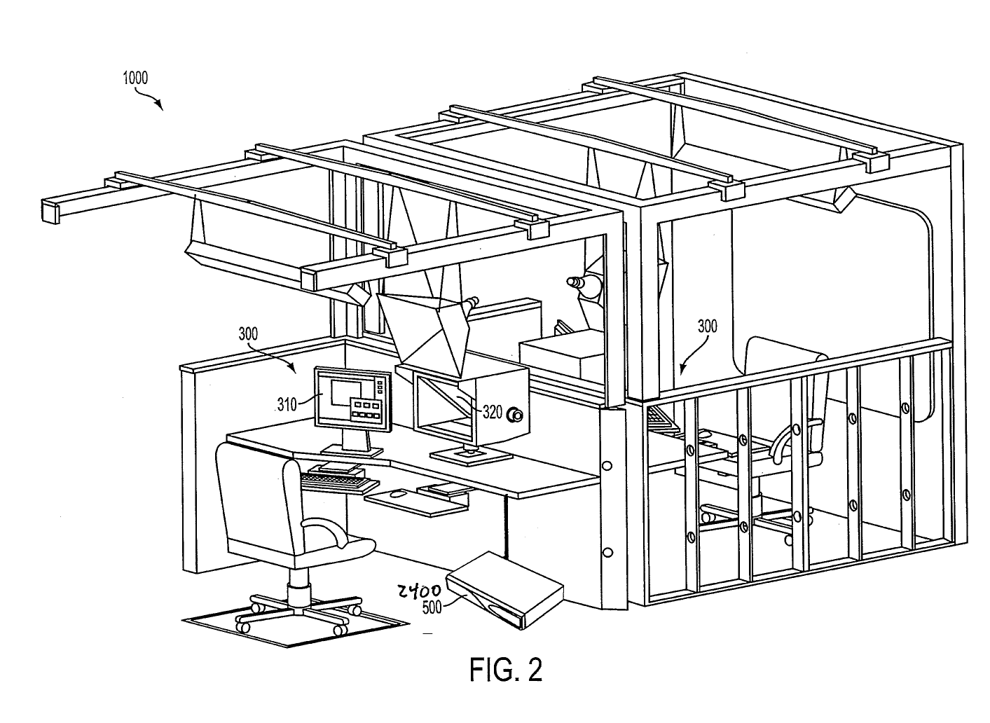

FIG. 3: Perspective view of an embodiment of the patient videoconference terminal.

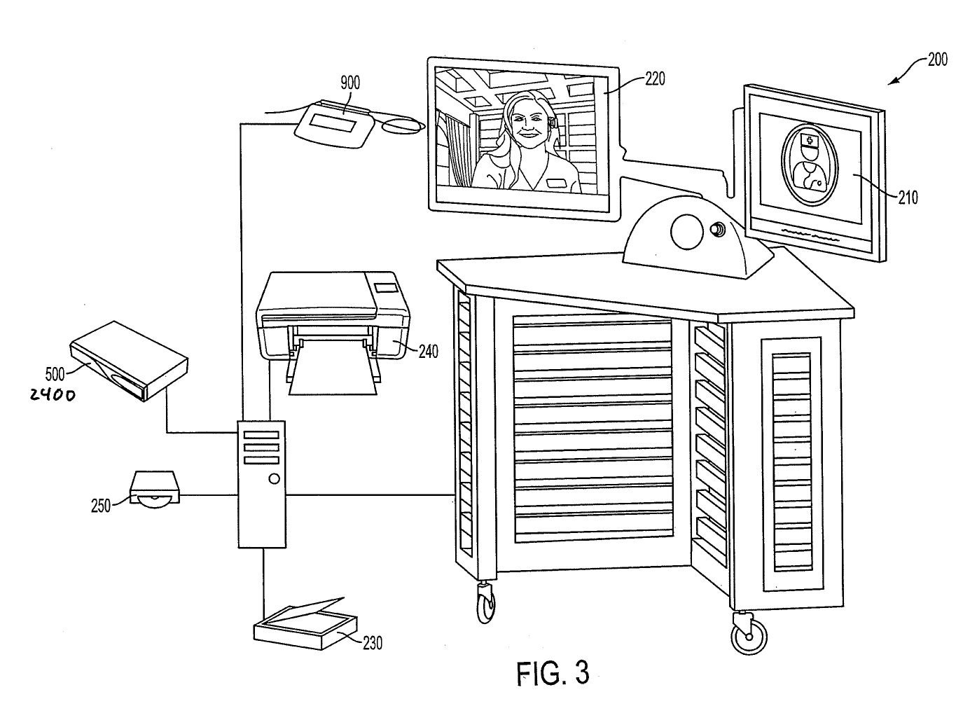

FIG. 4: Flowchart of an embodiment of the process for providing medical information.

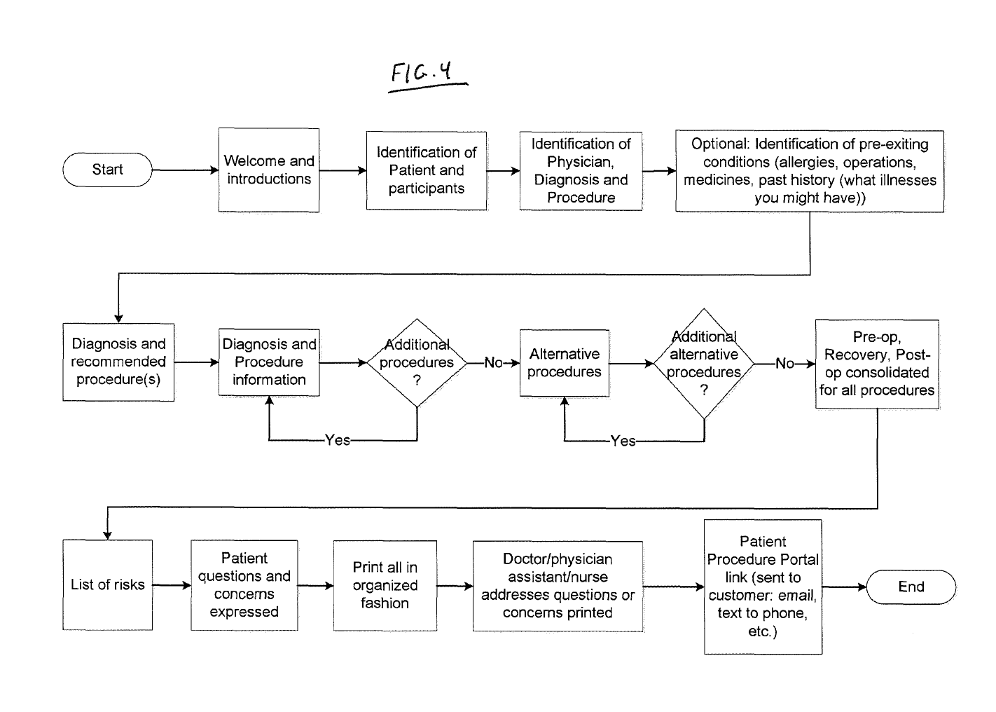

FIG. 5: Flowchart of scheduling function of an embodiment of the process.

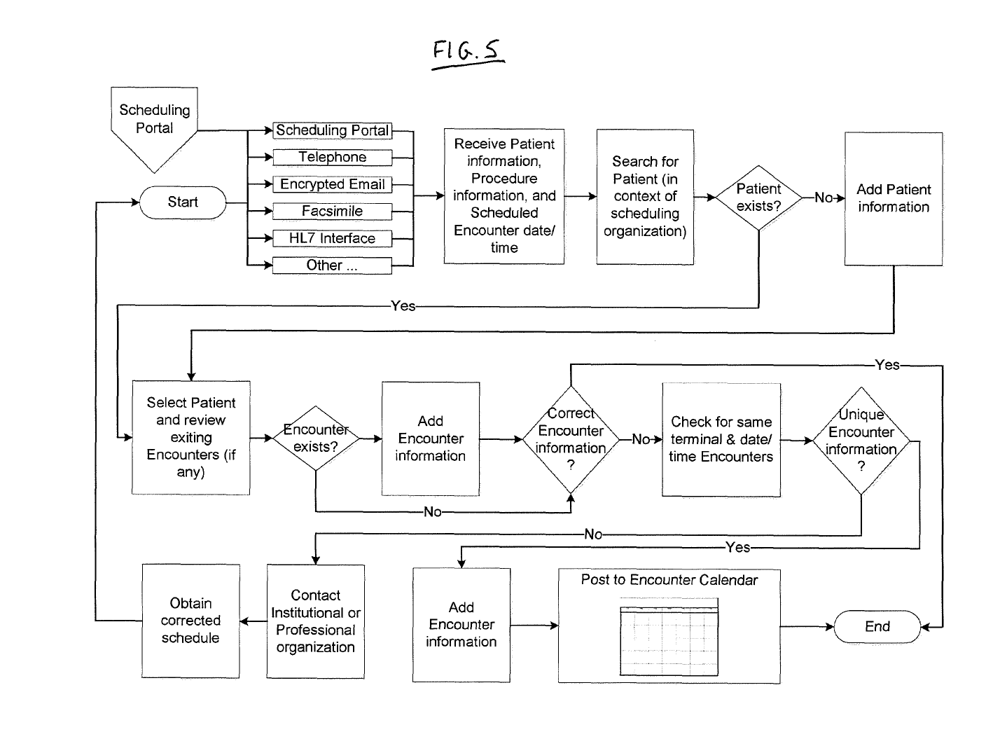

FIG. 6: Conceptual system diagram of tasks performed at the interviewer terminal, server, and patient terminal in an embodiment of the process.

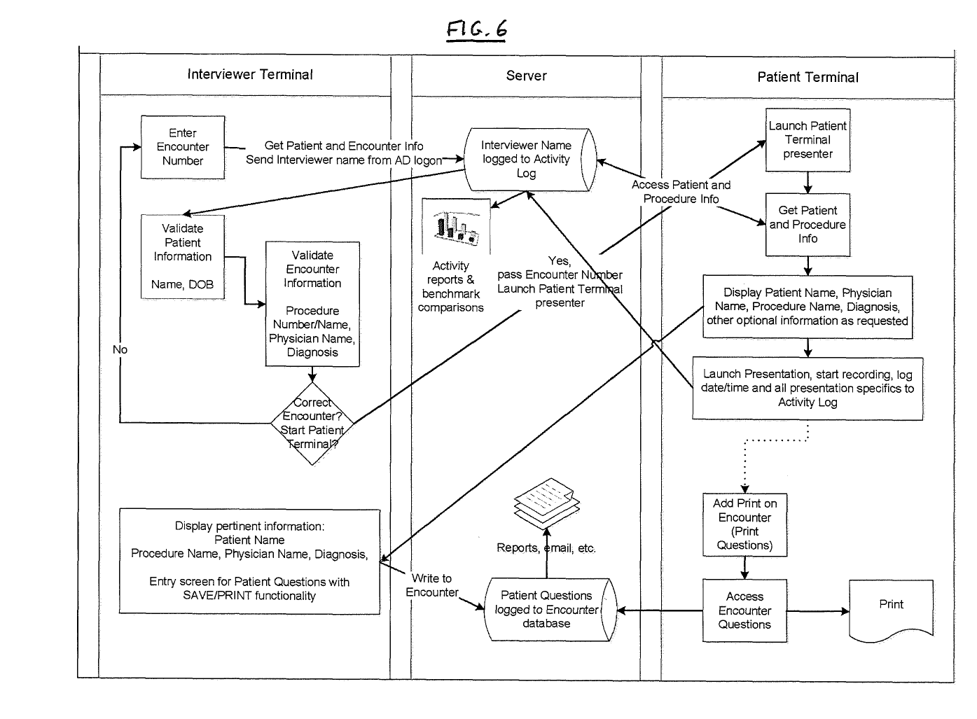

FIG. 7: Flowchart of an embodiment of the process for providing medical information showing the segregation of operations between the interviewer terminal, server, and patient terminal.

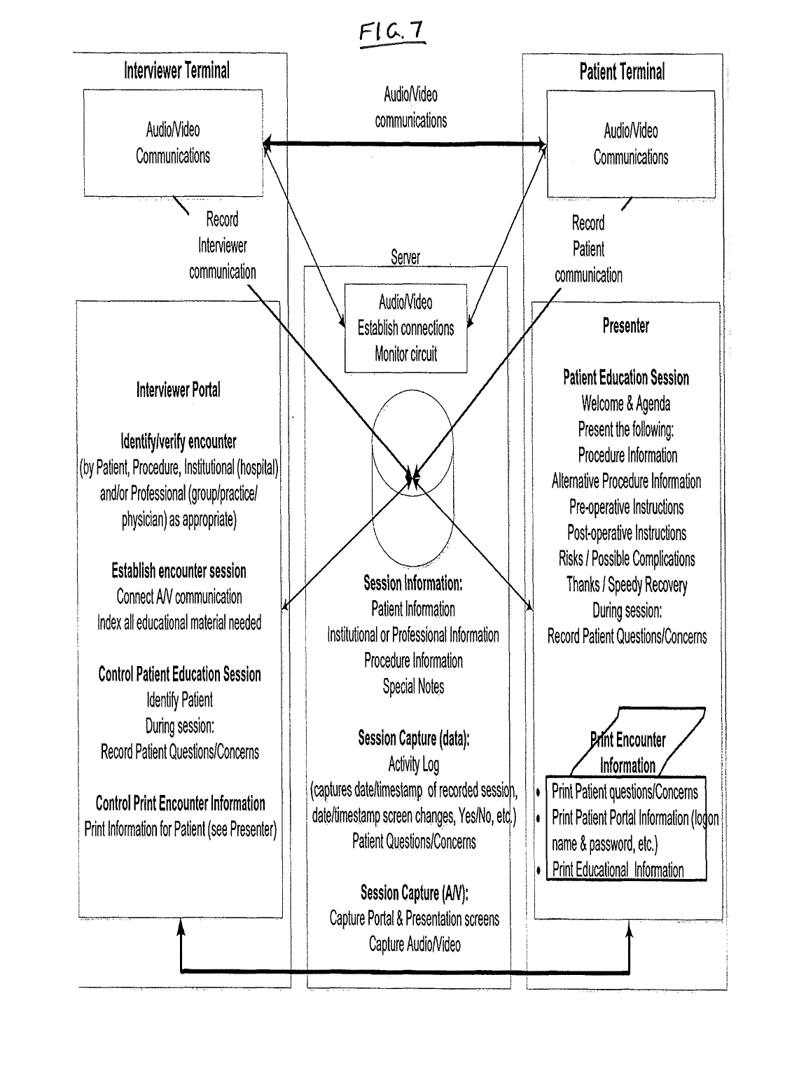

FIG. 8: Flowchart of login, authentication, and portal selection in an embodiment of the process.

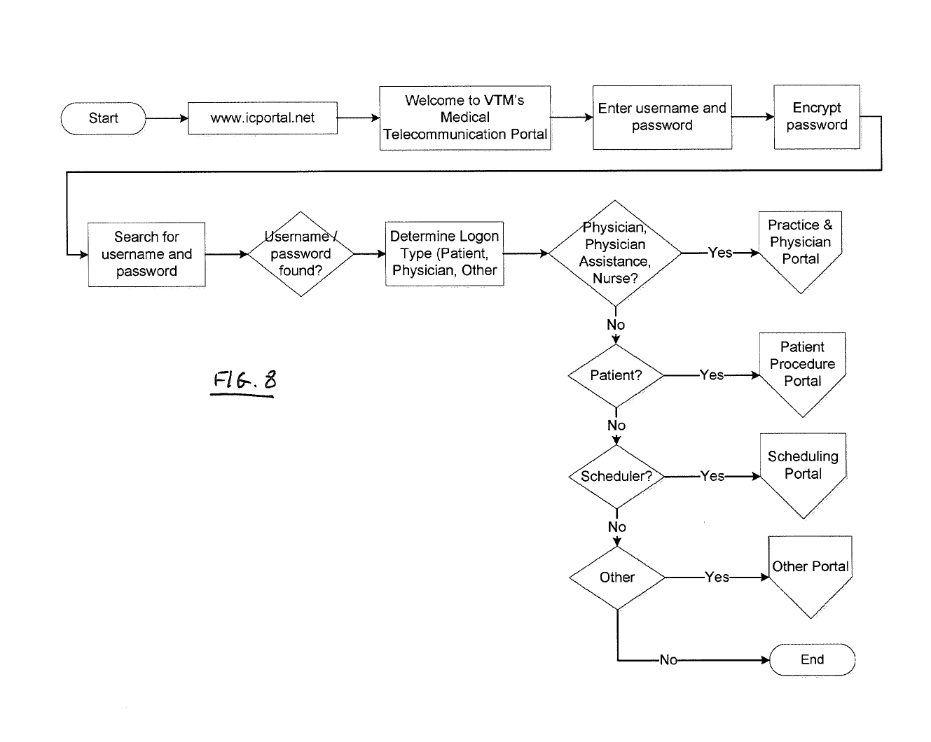

FIG. 9: Flowchart of an embodiment of the patient portal processes.

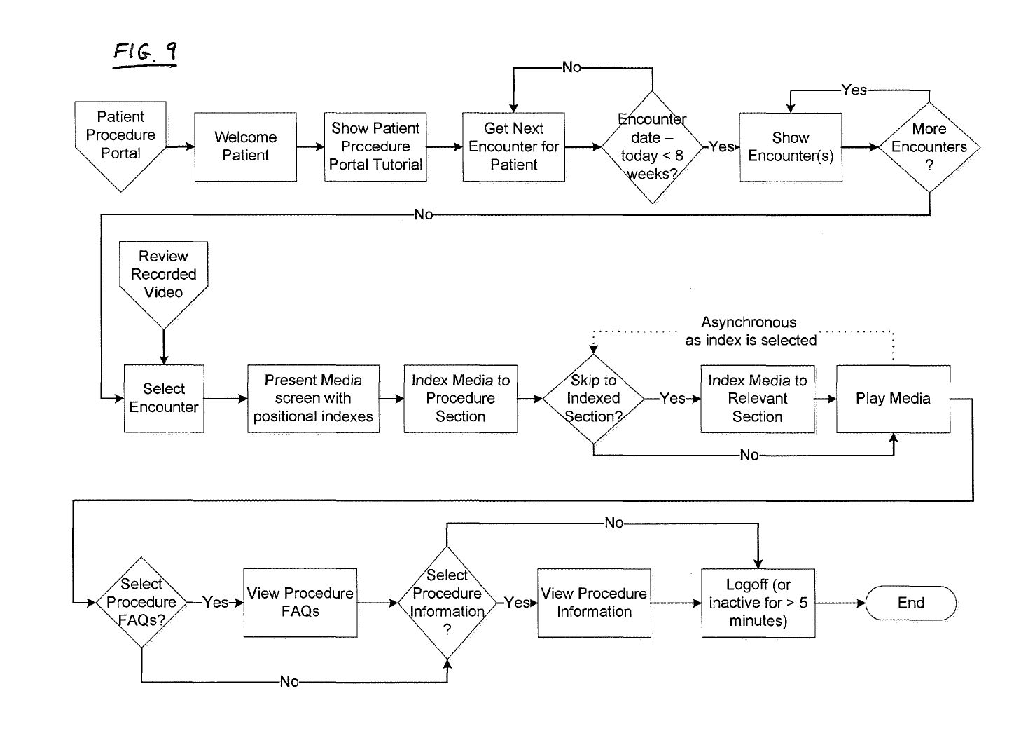

FIG. 10: Flowchart of an embodiment of the physician portal process.

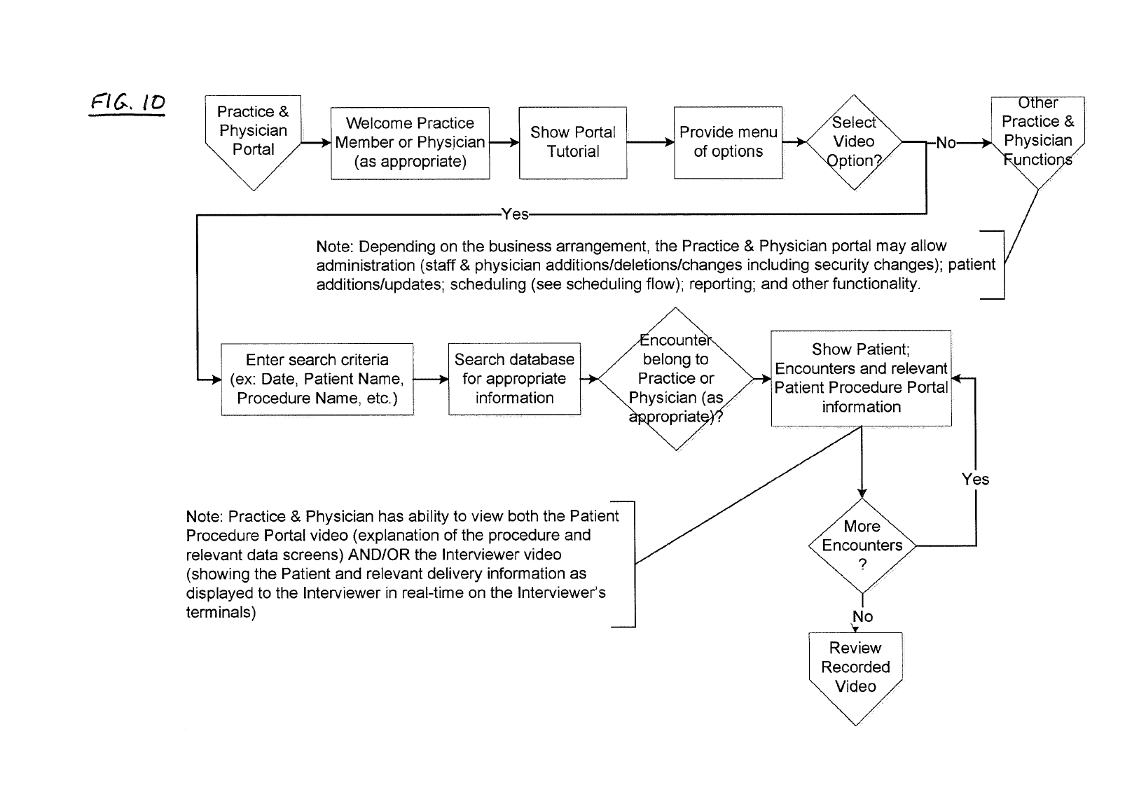

FIG. 11: Scheduling data collected from a physician's practice that did not employ the disclosed methods and systems to provide patient education of interventions.

FIG. 12: The scheduling data from FIG. 12 used in a model simulating the use of an embodiment of the disclosed methods and systems to provide patient education of interventions.

### DETAILED DESCRIPTION

### A. DEFINITIONS

With reference to the use of the word(s) “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

The term “consisting essentially of” means that, in addition to the recited elements, what is claimed may also contain other elements (steps, structures, ingredients, components, etc.) that do not adversely affect the operability of what is claimed for its intended purpose. Such addition of other elements that do not adversely affect the operability of what is claimed for its intended purpose would not constitute a material change in the basic and novel characteristics of what is claimed.

The term “about” as used herein refers to a value that may vary within the range of expected error inherent in typical measurement techniques known in the art.

The term “storage device” as used herein refers to a machine-readable device that retains data that can be read by mechanical, optical, or electronic means, for example by a computer. Such devices are sometimes referred to as “memory,” although as used herein a machine-readable data storage device cannot comprise a human mind in whole or in part, including human memory. A storage device may be classified as primary, secondary, tertiary, or off-line storage. Examples of a storage device that is primary storage include the register of a central processing unit, the cache of a central processing unit, and random-access memory (RAM) that is accessible to a central processing unit via a memory bus (generally comprising an address bus and a data bus). Primary storage is generally volatile memory, which has the advantage of being rapidly accessible. A storage device that is secondary storage is not directly accessible to the central processing unit, but is accessible to the central processing unit via an input/output channel. Examples of a storage device that is secondary storage include a mass storage device, such as a magnetic hard disk, an optical disk, a drum drive, flash memory, a floppy disk, a magnetic tape, an optical tape, a paper tape, and a plurality of punch cards. A storage device that is tertiary storage is not connected to the central processing unit until it is needed, generally accessed robotically. Examples of a storage device that is tertiary storage may be any storage device that is suitable for secondary storage, but configured such that it is not constantly connected to the central processing unit. A storage device that is off-line storage is not connected to the central processing unit, and does not become so connected without human intervention. Examples of a storage device that is off-line storage may be any storage device that is suitable for secondary storage, but configured such that it is not constantly connected to the central processing unit, and does not become so connected without human intervention. Secondary, tertiary, and offline storage are generally non-volatile, which has the advantage of requiring no source of electrical current to maintain the recorded information.

A storage device cannot be construed to be a mere signal, although information may be communicated to and from a storage device via a signal.

The term “telecommunications network” as used herein refers to a network capable of transferring information spatially by conducting signals, such as but not limited to electrical or optical signals. The network itself cannot be construed to be a mere signal. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). Information sent via a packet-switched network may be for example electronic mail, an SMS text message, and a digital file sent via file transfer protocol (FTP). Information sent via a circuit-switched network may be for example a voice mail message, a facsimile message, an SMS text message, or a digital file.

The term “processor” or “central processing unit” (CPU) as used herein refers to a software execution device capable of executing a sequence of instructions (“program”). The CPU comprises an arithmetic logic unit, and may further comprise one or both of a register and cache memory.

The term “variable” as used herein refers to a symbolic name corresponding to a value stored at a given memory address on a data storage device (although this address may change). The value may represent information of many types, such as integers, real numbers, Boolean values, characters, and strings, as is understood in the art. As used herein the value of a variable is always stored in a data storage device, and shall not be construed to refer to information only stored in a human mind. Any recitation of a variable implicitly requires the use of a data storage device.

The term “machine-readable format” as used herein refers to a medium of storing information that is configured to be read by a machine. Such formats include magnetic media, optical media, and paper media (punch cards, paper tape, etc.). Printed writing in a human language, if not intended or configured to be read by a machine, is not considered a machine readable format. In no case shall a human mind be construed as “machine readable format.”

The term “database” as used herein refers to an organized data structure comprising a plurality of records stored in machine-readable format.

### B. PROCESS

A process is provided for providing medical information pertaining to a medical intervention to a patient and documenting comprehension of the information by the patient. In a general embodiment, the process comprises: establishing a videoconference between the patient and a medical interviewer; providing a script to the medical interviewer based on the medical intervention; transmitting at least a portion of the script to the patient via the videoconference; transmitting a question to the patient via the videoconference to assess the patient's comprehension; and creating a machine-readable recording of the patient's response to the question.

The question to assess comprehension may be an oral request, a written request, or a symbolic request. An oral question may take any suitable form, such as asking the patient whether the patient has additional questions. Such embodiments have the advantage of relying on the interviewer's intuition to predict when the patient may not understand the information presented. In many cases the interviewer may discern from nonverbal queues that the patient does not fully understand, even if the patient has no further questions. To date automated systems have shown a poor track record in making these sorts of determinations.

Some embodiments of the process comprise constantly transmitting a live image of the interviewer's face to the patient via the videoconference throughout the interview. This has the advantage of establishing a face-to-face rapport, which has been demonstrated to significantly enhance communication. This reduces anxiety levels in the patient, enhances memory, and encourages interaction. In further embodiments, an audiovisual presentation is transmitted to the patient with additional information about the intervention, during which the live image of the interviewer's face is transmitted to the patient via the videoconference throughout. Such embodiments have the advantage of encouraging dialog about the additional information, as the image of the interviewer's face is a constant reminder that the option exists to present the interviewer with questions and concerns.

The process may further comprise transmitting a request for confirmation of understanding from the interviewer to the patient. Such a request may simply take the form of a spoken question. The question may be part of the script, or it may be made of the interviewer's own initiative. Such embodiments have the advantage of relying on the interviewer's intuition to predict when the patient may not understand the information presented. To date automated systems have shown a poor track record in making these sorts of determinations. In a similar manner the process may comprise replaying or rephrasing a portion of the script. Such replaying or rephrasing may be made of the interviewer's own initiative or may be scripted as required if the patient provides a certain response (or lack of response). The request for confirmation of comprehension may be an oral request, a written request, or a symbolic request. An oral request may take any suitable form, such as a request by the interviewer for a particular oral response from the patient, a request by the interviewer for the patient to take some action (such as press a button), or a request by the interviewer for the patient to sign a document.

The videoconference occurs between the patient and a medical interviewer. The interviewer is an individual sufficiently knowledgeable regarding the intervention in question to address common patient questions with the help of a script. The interviewer may be a medical professional, such as a physician's assistant or a nurse. In some embodiments the interviewer has no generalized medical training, but has been trained to discourse with a patient on the subject of the intervention. Such interviewers have the advantage of freeing up nurses and physicians' assistants at the provider's facility for more skilled and specialized tasks.

As the interview is conducted via videoconference, the interviewer may be at any geographic location that has a good telecommunications link. The interviewer may, for example, be located at a centralized telecommunications center akin to a video call center 1000. The “video call center” may be configured to conduct videoconferences with patients in multiple locations simultaneously. The video call center 1000 may comprise a scheduling database containing times and dates for videoconferences that allows videoconferences to be assigned to interviews in a time-effective manner.

The use of an interviewer has distinct advantages over relying solely on textual and graphical materials; it also has advantages over video or multimedia presentations that are not mediated by a live person. A live interviewer is better able to understand questions and better able to ascertain when the patient lacks understanding than a purely automated system. The sources of such lack of understanding may come from many sources, such as the patient's language proficiency, degree of literacy, or mental competence. The patient is more able to personally connect with a live interviewer, and more likely to understand the context behind what a live interviewer says. Interviewers may be provided with differing language capabilities, such that the patient may be matched to an interviewer who is conversant in the patient's preferred language. The process may thus further comprise receiving a language preference from the patient, and establishing the videoconference with a interviewer medically fluent in the preferred language. Alternatively, the process may further comprise establishing the videoconference to provide at least the audio portion to a medical interpreter who is proficient in the patient's preferred language. Further, a live interviewer may determine to emphasize a specific learning modality if they determine the patient will better comprehend the information. For example, a patient with poor eyesight may require textual or graphical information to be more fully explained orally.

The process may comprise noting an unanswered question and transmitting the unanswered question to a physician. The unanswered question will be noted initially by the interviewer, who may then electronically transmit the question to the physician. Transmission to the physician may be direct, or may occur through one or more intermediaries. Such embodiments have the advantage of allowing a physician to personally address questions of particular concern with the patient. The unanswered question may also be recorded.

The videoconference involves the use of at least two audiovisual terminals, as is known in the art. The terminals each comprise a display, a speaker, a microphone, and a camera. Each has a telecommunications interface, allowing audiovisual data to be transmitted and received with the other terminal.

The interviewer is provided with a script. The contents of the script are determined by the intervention in question; the contents of the script may also be determined by the patient's health records in combination with the intervention. The script will comprise one or more script segments relevant to the intervention. The script segments may be one or more of: a confirmation of the patient's identity, a confirmation of the recommended intervention, a request for confirmation of the patient's medical history, a description of alternatives to the intervention, a question regarding the patient's medical history, a description of potential adverse outcomes of the intervention, a description of pre-intervention measures to be taken by the patient, a description of post-intervention measures to be taken by the patient, a description of post-intervention measures to be taken by the patient specifically in the case of an adverse event, a description of how the intervention is performed, a description of how the patient will appear post-intervention, a description of how the patient will feel post-intervention, an answer to a frequently asked question, and a description of recommended actions to take in case of adverse events.

In some embodiments of the process the script will be modified during delivery based on an answer provided by the patient. For example, if the patient denies the accuracy of a datum in the patient's EMR, the script may be modified by the script engine to provide information that is relevant in light of the new information. In some embodiments the inaccuracy may be transmitted to a physician. In some cases such an answer by the patient may prompt the interviewer to halt the interview and summon a medical professional. In some such embodiments the summoned medical professional is the patient's physician. One illustrative example could involve a patient who responds to a question in the script that they are using a blood thinner prescribed by another doctor. In this example, the interviewer's entry would cause the script engine to send this information electronically to the physician's office and have the interviewer confirm with the physician's office that this information was received. In some embodiments of the process such notification may be sent to the physician if the patient has any question that cannot be satisfactorily answered by the interviewer.

In some embodiments of the process nonverbal electronic communications may be exchanged between the interviewer and the patient's healthcare provider. In such embodiments the interviewer may inform the healthcare provider of the status of the interview, for example: the readiness of the patient for the intervention (for example at the successful conclusion of the interview), the unreadiness of the patient for the intervention (for example if the patient has additional unanswered questions at the end of the normally allotted time for the interview), a need for a more highly trained medical professional (for example a need for a physician to come talk to the patient if the patient reveals a possibly complicating condition), the need to repeat the interview at another time (for example if the patient arrives for the interview in a state of intoxication), and a scheduling request for a future interview.

Such exchange of nonverbal communication may be advantageously accomplished over a telecommunications network. Suitable types of nonverbal electronic communications that may be transmitted over a telecommunications network include an SMS text message, an electronic mail message, and a real time chat message.

In some embodiments of the method a portion of the patient's health record (such as an EMR) is accessible to the interviewer. In such embodiments the interviewer may check to determine whether the health record contains data that should affect the information provided to the patient. For example, if the intervention is a course of drugs, and the health record shows that the patient suffered a negative reaction to a related drug, then the interviewer would caution the patient to be aware of possible negative reactions and cease use of the drug should the side effects manifest.

At least a portion of the script is transmitted to the patient. In some embodiments the script will be transmitted in discrete segments. This will generally take the form of the interviewer reciting the portion of the script during the videoconference. In addition, portions of the script may be provided as a multimedia presentation, as audio content, as text, or as graphics. The script may include instructions for the interviewer to request input from the patient. For example, the interviewer may request the patient to confirm whether a piece of information was understood; the interviewer may request identifying information from the patient; and the interviewer may request the patient explain a piece of the information that was provided to the patient to confirm understanding.

In some embodiments of the process a portion of the script may be provided in the form of text on a display. This could be the same as a portion of the script that is delivered orally, or it could be a separate portion that is not delivered orally. In some embodiments of the process the entire script is provided orally, textually, or both.

A request to confirm a datum in the patient's medical record may also be transmitted from the interviewer to the patient by way of the videoconference. In this way any information that is particularly relevant to the intervention in question can be directly checked with the patient, and the patient's response recorded.

The patient's response to the request for confirmation of comprehension will be recorded in machine-readable format. The recording will then allow the patient's understanding to be evaluated in the future when the recording is played.

The process may comprise creating a machine-readable recording of the videoconference. The recording of the videoconference may be a recording from the point-of-view of the interviewer. A recording from the point-of-view of the interviewer would include at least the audiovisual data of the patient during the interview; in some embodiments it will also include the audio from the interviewer. The recording from the point-of-view of the interviewer may also include one or more of: the script as visible to the interviewer, the patient's medical record as visible to the interviewer, and the contents of a data display as visible to the interviewer (the interviewer's data display is described more fully below).

The recording of the videoconference from the interviewer's point-of-view may be copied to a secure memory storage device 250 for later access. As this recording may be necessary evidence in a legal proceeding, the recording may further comprise chain-of-custody data, as known in the art.

The recording of the videoconference may be a recording from the point-of-view of the patient. The recording from the point-of-view of the patient may include the audiovisual data of the interviewer during the interview; in some embodiments it will also include the audio from the patient. The recording from the point-of-view of the patient may also include the contents of a data display that is visible to the patient (the patient data display is explained more fully below).

Some embodiments of the process comprise creating a machine-readable recording of the videoconference from the point-of-view of the patient and creating a machine-readable recording of the videoconference from the point-of-view of the interviewer. These two recordings may be distinct files, or they may both be present in the same file.

Some embodiments of the process comprise creating a recording of the entire videoconference from either (or both) points of view.

The process may comprise transmitting additional information about the intervention to a data display visible to the patient during the videoconference, wherein the additional information is in a form selected from the group consisting of: text, graphics, video, and audio-visual. The data display may be used for various useful purposes. Graphical information could include illustrations and animations to demonstrate facts about the intervention. This could include graphical instructions regarding home care, illustrations of a surgical intervention, photographs of pills to aid in identification, or touch-screen buttons (in those embodiments in which the data display is a touch screen). Textual information will be any type of written information, including written questions which the patient is prompted to answer. Video and audiovisual information could include footage or animated simulations of the intervention, with or without explanation. In a specific embodiment the additional information is an audiovisual presentation.

The additional information may require a significant amount of memory; consequently some embodiments of the process comprise downloading the additional information to a data storage device 250 that is local to the patient prior to the interview. This measure could have the advantage of increasing the rate at which the additional information can be accessed during the interview, as transmission speeds over local networks and connections are generally faster than transmission speeds over non-local networks. Some such embodiments comprise downloading the additional information to a server that is collocated with the patient prior to establishing the videoconference. Further embodiments comprise downloading the additional information to the patient videoconference terminal 200.

The additional information may be displayed in a patient data display area 210. The patient data display area 210 may define an entire display device, or a portion of a display device. In some embodiments of the process the patient data display area 210 is distinct from and does not overlap a patient videoconference display area 220 (on which is displayed the image of the interviewer). Such embodiments have the advantage of allowing the interviewer's face to be constantly displayed, even when additional information is presented.

The interviewer's terminal may also comprise a data display. A variety of types of information may be transmitted to the interviewer's data display. The information may comprise one or more of the script, a portion of the script, a mirror of the patient data display, an image from a scanner 230 co-located with the patient, a portion of the patient's medical record, and data reflecting input provided by the patient.

The recording of the videoconference may be made accessible after the interview by the patient. In some embodiments of the process the videoconference is accessible to a second person designated by the patient. The second person may be, for example, the patient's next-of-kin, the patient's guardian, the patient's caregiver, or the patient's other designee. Access may be granted by providing a controlled web site. Access may also be granted by providing an application for a mobile computing device. Any suitable access control mechanism known in the art may be employed. Such a mechanism may in some cases comply with an established privacy standard, such as those established in the United States under the Health Insurance Portability and Accountability Act.

Typically the access control mechanism will involve requesting a username and password prior to providing access to the recording. The recording may then be played as needed, to facilitate the patient's care or to satisfy the patient's understanding. The recording may also be made available to one or more healthcare providers responsible for the patient's care. The recording may be made available over a telecommunications network, one suitable example of which is the Internet. If the network is the Internet, the recording may be made available for downloading, or it may provided by streaming data to the recipient. In a specific embodiment, the recording is made available in streaming format via the World Wide Web. The recording may comprise an index to anchors at certain points during the recording to allow the viewer to jump to certain points without viewing the previous content.

In some embodiments of the process the script is generated based on the intervention and the patient's health records. In some embodiments the script is generated at least partially based on a datum from the patient's health record (such as an EMR), and based on any modifications to the intervention script required by specific physicians or medical practice groups. The datum may be anything that is known to be likely to affect the course of care, including: the patient's age, the patient's sex, the patient's ethnicity, an allergy, a disability, a contraindicated combination of drugs, a contraindicated combination of drug and procedure, a contraindicated combination of procedures, a genetic risk factor, an existing condition, an existing medication regimen, a prior medication regimen, and a prior condition. Some embodiments of the process comprise auto-generating the script by a script engine. The script engine may generate the script based on the intervention. The script engine may modify the script based on a datum from the patient's health record (such as an EMR), and based on any modifications to the intervention script required by specific physicians or medical practice groups.

The process may comprise printing one or more documents at the patient's site. The printer 240 may be configured as part of a network, such that the interviewer can transmit files to be printed. Some embodiments of the process comprise printing an informed consent form at the patient's site. Such embodiments may further comprise receiving a scanned image of the signed consent form; a scanner 230 at the patient's site will be configured as part of a network, such that the interviewer can view scanned documents. Some embodiments comprise printing an information sheet pertaining to the intervention. The information sheet will be based on the intervention. In some embodiments of the process the information sheet may be modified by an information sheet engine based on a datum from the patient's health record (such as an “EMR”) or based on any modifications to the sheet required by specific physicians or medical practice groups. The information sheet engine is a program, or collection of interacting programs, configured to transform the data in the information sheet as a function of the datum. The datum may be anything that is known to be likely to affect the course of care, including: the patient's age, the patient's sex, the patient's ethnicity, an allergy, a disability, a contraindicated combination of drugs, a contraindicated combination of drug and procedure, a contraindicated combination of procedures, a genetic risk factor, an existing condition, and a prior condition.

Some embodiments of the process comprise receiving the affirmation of consent as a digital signature. The digital signature may be received by any means known in the art. In one embodiment of the process, a digital signature is received via a signature pad 900. This may be accompanied by providing to the patient an informed consent form, either in the form of a printed document or in the form of textual data on the data display. The digital signature may also be a text signature, such as an identifying string of characters between two slash characters.

The results of the videoconference may be recorded, in whole or in part, in the patient's health record (such as an EMR). If so, the process may comprise creating a machine-readable recording of the videoconference; recording a first datum in the patient's health record (such as an EMR), said first datum indicating the content of the information transmitted to the patient; and recording a second datum in the patient's health record (such as an EMR), said second datum indicating the content of a response received by the patient. As a result, the health record (such as an EMR) will contain data showing what information was provided to the patient, and whether the patient gave consent or affirmed understanding of the information. Storing such information in the health record (such as an EMR) has the advantage of making it available to any healthcare provider or other entity with access to the health record (such as an EMR). These data may be stored in the health record (such as an EMR) in any suitable form. For example, the data indicating the content of the information may be stored as ASCII text summarizing the information provided, or referring to a specific script by serial number (or other identifier). The data indicating the content of a response received by the patient may be stored as a simple Boolean variable, indicating either “consent” or “no consent.” Such simple variables have the advantage of requiring little memory. Alternatively the data could be recorded in the health record (such as an EMR) as video files of the pertinent parts of the videoconference. Video files have the advantage of providing more specific information, albeit at a much larger file size.

The process may further comprise sending a notification to a healthcare provider in machine-readable format that the patient has provided informed consent. The notification may be sent, for example, via a telecommunications network. The notification may be an electronic communication, such as electronic mail or facsimile. The electronic communication may be automatically generated, or it may be composed by the interviewer. The notification may comprise an indicator of the information provided and an indicator of consent. The indicator of the information provided may be a summary, a reference to a particular script, a list of one or more unanswered questions, a date/time record of the interview, or a verbose recounting of the information provided. The notification may be accompanied by a video file of the interview. Alternatively, the recording of the videoconference may be made available to the healthcare provider over a telecommunications network; in a specific embodiment, the network is the Internet. In embodiments in which the network is the Internet, the recording of the videoconference may be made available to the healthcare provider via such means as FTP, a file sharing system, a streaming video server, or the World Wide Web.

Some embodiments of the process comprise transmitting a notification to a healthcare provider in machine-readable format of the status of the interview. For example, the notification may inform the healthcare provider that the teleconference has started and is ongoing between the patient and the interviewer. In a particular embodiment the staff at a primary healthcare provider site would be notified that an interview had been initiated between a patient using a terminal local to the provider and a remote interviewer. As another example, the notification may inform the healthcare provider that the teleconference has been concluded. In a particular embodiment the staff at a primary healthcare provider site would be notified that the patient is now finished with the interview, prompting the staff to provide any further services or guidance to the patient. The notification may be any type of notification described as a suitable notification that informed consent has been received.

The recording of the videoconference provided to the healthcare provider may be from the point-of-view of the interviewer or the patient. In either case, it may further comprise a visual presentation complementary to the script on a display visible to the patient. The visual presentation may have been transmitted to the patient data display. The recording may further comprise the contents of the patient data display during at least a portion of the interview. Of course the recording may also comprise an audio recording of the patient's statements, and may additionally comprise the audio portion of the interviewer's statements.

After the interview, the health record (such as an EMR), or any portion of it, may be retained or discarded by the system that provided it to the interviewer. This may be in compliance with a predetermined retention policy. In a similar vein the recording of the videoconference may be retained for a predetermined time to allow access by the patient, healthcare providers, or other parties.

The process may also comprise the automated scheduling of the interview. Such embodiments comprise receiving a request to schedule an interview, the request comprising a datum identifying the intervention. The request may additionally comprise one or more of an interview time, an interview location, the patient's electronic medical record, and a special instruction regarding the interview. The process may further comprise transmitting an electronic request to the patient to participate in the interview. The notification may be any that are described above as suitable for transmitting notifications to the health care provider. The notification may contain a means to confirm or assent to the interview. For example, the notification may be an electronic mail message or SMS text message containing a URL “link” that allows the patient to communicate confirmation of the interview time. In another example, the notification is an automated telephone message to the patient that prompts the patient to confirm the interview time by touching a key on the telephone's keypad.

### C. SYSTEMS AND DEVICES

Systems 100 for providing medical information pertaining to a medical intervention to a patient and documenting comprehension of the information by the patient are provided. A general embodiment of the system 100 comprises: a patient videoconference terminal 200 (“patient terminal”); an interviewer videoconference terminal 300 connected to the patient videoconference terminal 200 via a data connection 400 capable of conveying audiovisual data (“interviewer terminal”); an audiovisual recording device 500 configured to record a videoconference between the patient terminal 200 and the interviewer terminal 300; a transaction server comprising a variable identifying the intervention; and a script server 700 comprising a plurality of scripts or script segments. Another general embodiment of the system 100 comprises: a means for two-way audiovisual communication between the patient and a medical interviewer 2000; a means for digitally storing a plurality of script segments each corresponding to an intervention 2100; a means for accessing the script segments by the interviewer 2200; a means for accessing the patient's electronic medical record 2300 by the interviewer; a means for recording the two-way audiovisual communication between the patient and the interviewer 2400; and a means for storing the two-way audiovisual communication between the patient and the interviewer 2500.

The patient videoconference terminal 200 may be any device capable of two-way audiovisual communications over a telecommunications network. The patient videoconference terminal 200 may be a device that is specifically configured for videoconferencing, or it may be a more generalized communications device that has been configured or programmed to provide videoconferencing. A specific embodiment of the patient videoconference terminal 200 is a general computing device comprising a processor, memory, and a communications interface. Such a general computing device may comprise additional components, such as drivers for a display device, camera, and other peripheral devices as necessary to carry out a video conference.

One embodiment of the patient terminal 200 is a general purpose computer connected to peripheral devices and programmed to provide videoconferencing. The peripheral devices will include a camera, a microphone, a speaker, a display, and a communication interface. The peripheral devices may additionally include a printer 240. In a specific embodiment the general purpose computer is a personal computer, such as a desktop or a laptop personal computer. It is conceivable that the general purpose computer could be a component of a mobile computing device, such as a personal digital assistant (PDA), a smart phone, or a tablet device.

Some embodiments of the system 100 comprise a means for transmitting a notification to a health care provider. The health care provider may be the practice of the primary care physician for the patient. Such notifications may include a notification that the interview has commenced or a notification that the interview has concluded. Examples of means for transmitting the notification include an electronic mail system, an automated phone messaging system, and an SMS text message system. Other embodiments may include a signal to the indicator light management system at the physician's office to change the indicator light pattern outside the interview room.

In some embodiments of the system 100 the patient videoconference terminal 200 comprises a patient data display area 210. The data display area is capable of presenting textual and graphical data. The data display area may be a portion of the display on which the videoconference image is shown. Alternatively, the data display area may be on a separate display device. The data display area is connected to receive data through a telecommunications network and display such data. The data display may be used, for example, to present the text of a script delivered by the medical interviewer, or to present graphics that illustrate what the medical interviewer is orally conveying. Such embodiments may be said to also comprise a videoconference display area, which is an area on a display device capable of presenting live video feed from the interviewer.

The patient videoconference terminal 200 may comprise additional peripheral devices, such as use input devices and output devices. Examples of such additional peripheral devices include a printer 240, a scanner 230, a keyboard, a cursor control device (such as a mouse, trackpad or trackball), a touch screen (which may be the main display, the data display, or a separate display device), a digital signature pad 900, a card reader, a card scanner, an RFID reader, and additional cameras. Input devices will be configured to transmit the patient's input to the interviewer's terminal, so that the input is displayed to the interviewer. The input devices may transmit from the patient to the interviewer various information, including: identifying information, consent, lack of consent, understanding, and lack of understanding. A signature pad 900 is particularly well suited for receiving and transmitting consent. Card readers are well suited for identifying the patient, as are various biometric devices. Output devices may be configured to receive commands and data from the interviewer's terminal. For example, the printer 240 may be configured to print a file sent from the interviewer's terminal, so that the interviewer can provide the patient with printed forms. In some embodiments of the system 100, the patient videoconference terminal 200 comprises a scanner 230 configured to transmit an image of a scanned document to the interviewer terminal 300.

The interviewer terminal 300 may take any of the forms described as suitable for the patient videoconference terminal 200. In some embodiments of the system 100 the interviewer terminal 300 comprises an interviewer data display area 310. The interviewer data display area 310 may encompass a screen of a display device, or it may be a portion of the screen of a display device. The interviewer data display may be any display disclosed as suitable as the patient data display. The interviewer terminal 300 may also comprise an interviewer videoconference display area 320. The interviewer videoconference display area 320 may encompass a screen of a display device, or it may be a portion of the screen of a display device. A specific embodiment of the interviewer terminal 300 is a general computing device comprising a processor, memory, and a communications interface. Such a general computing device may comprise additional components, such as drivers for a display device, camera, and other peripheral devices as necessary to carry out a video conference. In some embodiments of the interviewer terminal 300, the script is presented on the same display device as the interviewer videoconference display area 320; in further embodiments the script may overlap or be superimposed on the interviewer videoconference display area 320.

In some embodiments of the system 100, the interviewer terminal 300 comprises a workstation comprising: a videoconference display area that is transparent when viewed from the side opposite the interviewer; a remote feed display area; a workstation camera positioned on the side of the videoconference display opposite the interviewer and positioned to capture an image of the interviewer's face; a workstation microphone positioned to capture the interviewer's voice; a connection to a patient videoconference terminal 200 via a telecommunications network; a connection to at least one of a database server and an applications server; and a computing device connected to the patient videoconference terminal 200 and configured to send and receive data with the patient videoconference terminal 200. The workstation may comprise a local data display area. In some embodiments of the workstation the remote feed display is a reflective surface; the workstation comprises a mirror-image remote feed display device positioned to provide a remote feed display image on the reflective surface that is visible to the interviewer in the correct orientation; and the local data display area is on a local data display device positioned immediately adjacent to the reflective surface.

A particular embodiment of the interviewer videoconference terminal 300 is a computer comprising a user interface that allows the interviewer to view the image of the patient's face captured by the patient videoconference terminal's 200 camera, allows the interviewer to understand the patient's speech transmitted from the patient videoconference terminal's 200 microphone, allows the interviewer to view images of documents captured by any scanner 230 or document camera that may be part of the patient videoconference terminal 200, and allows the interviewer to understand information provided by the patient via other input devices (such as a touch-screen or a card reader). In the context of this paragraph, the term “understand” indicates that the information is provided in a manner that can be perceived by the interviewer or another observer (either contemporaneous or observing recorded information at a later time); this may include displaying text or images on the interviewer's monitor, producing synthesized or transmitted speech, or printing a document at the interviewer's location. In some embodiments, the patient's speech may be translated into text and displayed to the interviewer. Of course, the patient's speech may simply be reproduced by speakers at the interviewer's location. Similarly, sound or visual cues may be provided to the interviewer to signal any type of event or input.

The computer connected to the user interface may be a standalone unit, such as a desktop or laptop computer, comprising a processor, primary storage, secondary storage, and various peripherals as known in the art. The computer may be shared among multiple interviewers, each interviewer using a terminal connected to a single computing device (known as a “dumb terminal”). The interviewer terminal 300 is provided with software for sending and receiving information between the interviewer terminal 300 and the patient terminal. Such software may include virtual telephony software and teleconferencing software to communicate with the patient. The software on the interviewer terminal 300 may also include software to read captured images transmitted from the patient terminal, to send commands to the patient terminal, and to receive information from other devices on the patient terminal such as the card reader, the card writer, and the cash dispenser. The interviewer terminal 300 may also be provided with software for viewing patient medical records from an EMR database.

The remote feed display area provides information that is obtained at the patient terminal. Examples of such information include an image of a face of the patient, an image of a document scanned at the patient videoconference terminal 200, an image of a driver's license, an image of a health insurance card, and an image from a signature pad 900.

In some embodiments of the interviewer's remote feed display area, the display area is a reflective surface that reflects an image of a remote feed display device positioned to provide a remote feed display image on the reflective surface that is visible to the interviewer in the correct orientation. The data display device will be configured to display images and/or information in mirror-image if it is directly reflected to be visible to the interviewer. Of course, if there is another intervening mirror, the remote feed display device need not display a mirror image, as is understood in the art.

The camera is positioned such that, when the interviewer looks at the remote feed display, the interviewer's gaze is at least approximately directed at the camera. This allows the interviewer to view the remote feed display while appearing to maintain his or her attention on the videoconference.

The local data display area serves to display information that is not collected by the patient terminal. Such information includes information from a records database server pertaining to the medical history of the user. In some embodiments of the workstation the local data display area is on the same display device as the remote feed display area. Such configurations have the advantage of requiring fewer display devices. They also have the advantage of allowing the interviewer to view the information on the local data display without appearing to divert his or her attention from the videoconference. In some embodiments of the workstation the local data display area is on a local data display device positioned immediately above or immediately below the remote feed display area such that the interviewer can view both the local data display area and the remote feed display without significantly turning the interviewer's head to the left or to the right and the local data display area is on a local data display device positioned immediately above or immediately below the reflective surface such that the interviewer can view both the local data display area and the remote feed display area without significantly turning the interviewer's head to the left or to the right. In alternate embodiments of the interviewer workstation the local data display is positioned to the right or left of the reflective surface. This configuration has the advantage of causing the interviewer's head to turn when the interviewer is looking at the local data display, as opposed to conversing with the patient. As a result the patient is aware through the interviewer's body language of when the interviewer is reading (or entering) data. Some embodiments of the workstation comprise a local data display above or below the reflective surface and a second local data display to the left or right of the reflective surface.

Some embodiments of the workstation employ a chroma key system to provide different virtual backgrounds during the videoconference. Some embodiments of the workstation comprise a chroma key screen positioned on the side of the interviewer opposite the camera. In such embodiments the computing device has access to one or more chroma key background images in machine-readable format. In further embodiments the background images are stored in machine-readable format in a background library, in which the background corresponds to specific services or groups of services. Chroma key technology is well known in the art, and various known permutations and variants can be used with the workstation.

The data connection 400 may be any type of connection that is capable of conveying data at sufficiently high speeds to carry out the methods described herein. For example, the data connection 400 between the interviewer terminal 300 and the patient terminal must be at least capable of carrying real-time audio and video at sufficiently high quality to provide intelligible speech. In some embodiments the connection is capable of carrying synchronized audio and video. An example of a suitable connection between the terminals is a T1 line. Others are known in the art and are not recited here. The connections will comprise other structures, such as routers and junctions, as needed.

In some embodiments of the system 100 the interviewer videoconference terminal 300 is a component in a medical interviewer video call center 1000, said video call center 1000 comprising a plurality of interviewer videoconference terminal 300s.

The system 100 may comprise a communications module to allow the exchange of electronic messages between the interviewer terminal 300 and a computing device associated with the patient's healthcare provider. In many cases, the interview will occur at the offices of the healthcare provider, so the healthcare provider will be collocated with the patient during the interview. Some embodiments of the communications module are configured to allow the exchange of SMS text messages, e-mail messages, or both.

Some embodiments of the system 100 comprise a web server 800. The web server 800 may be any suitable device, as is well known in the art. Some embodiments of the web server 800 comprise a recording of the videoconference generated by the audiovisual recording device 500; a module for providing access to the recording via a packet switched network; and a module for regulating access to the recording to at least one of the patient, the patient's next-of-kin, or the patient's designee. To gain access to the recording a user transmits an HTTP request to the web server 800 (this may be an HTTPS request if the server uses that secure protocol). The user may be required to provide identifying or authenticating information, as described above. The user then gains access to a viewable version of the recording, for example as a downloaded file or as a streaming file. As described above, the streaming video file may be indexed to allow the viewer to jump to various points in the stream.

The audiovisual recording device 500 may be a hardware device, software running on a computing device, or a combination of hardware and software. One suitable example of the audiovisual recording device 500 is a digital video recorder (DVR). Another is video recording software that stores audiovisual data in any suitable format, such as CCIR 601, MPEG-4, MPEG-2, MPEG-1, H.261, H.263, H.264, or Theora. The recording device may have an audio mixer to allow the direct input of the patient's microphone to be mixed with the interviewer's audio and optionally pre-recorded audio from any presentation. The mixed audio signal is fed to the audiovisual recording device 500 or the audio input utilized by the recording software. The audio mixer may be a hardware device (such as a mixing board) or software capable of mixing multiple audio feeds.

The transaction server contains a variable identifying the intervention. It may further comprise a medical record pertaining to the patient, for example an EMR or a portion thereof. The record may be part of a greater database of patient records. The transaction server allows records to be queried and searched, and allows records to be downloaded as needed by the interviewer. In some embodiments of the system 100 the transaction server allows the record to be revised to reflect that the patient has received information or given informed consent, as described above.

Some embodiments of the system 100 comprise a secure memory storage device comprising a recording of a videoconference. The recording may be any that have been described above, including the recording from the point-of-view of the patient and the recording from the point-of-view of the interviewer. The secure memory storage device will permit access only under limited conditions. Some embodiments of the memory storage device may be offline storage. Some embodiments of the secure storage device comprise security systems requiring strict authentication of a user's identity before granting access to the data on the device. Further access software may be provided to control which files may be accessed by which users. A common example of such software is encryption software, which would encrypt the recording and require a user to provide the encryption key in order to gain access to the file.

The script server 700 comprises a file containing a script. The script comprises information relevant to a given intervention. The script may be a single comprehensive document, or it may contain information relevant under only certain circumstances. Some embodiments of the system 100 comprise a script engine that assembles a plurality of scripts or script segments based on the intervention and based on data from the patient's medical record. The script engine is one or more programs running on one or more computing devices which access the scripts on the script server 700. In an exemplary embodiment, the script engine concatenates a basic script based on the intervention with an auxiliary script based on a complicating factor. For example, if the intervention is an open surgery, and the script engine reads in the patient's health record (such as an EMR) that the patient has been prescribed blood thinner, the script engine may concatenate an instruction to cease taking blood thinner for a period surrounding the surgery.

Some embodiments of the system 100 comprise a scheduling engine running on one or more scheduling servers. The scheduling server may function as a server for one or more additional purposes, or it may be a dedicated scheduling server. The scheduling engine comprises a program or interacting group of programs for the automated scheduling of the interview. The scheduling engine will be configured to perform any embodiment of the automated scheduling of the interview described above.

A memory storage device is provided, comprising non-transitory machine-readable-media on which is stored a program which, when read by a computing device, causes the computing device to execute the steps of any of the processes described above.

### D. EXAMPLE

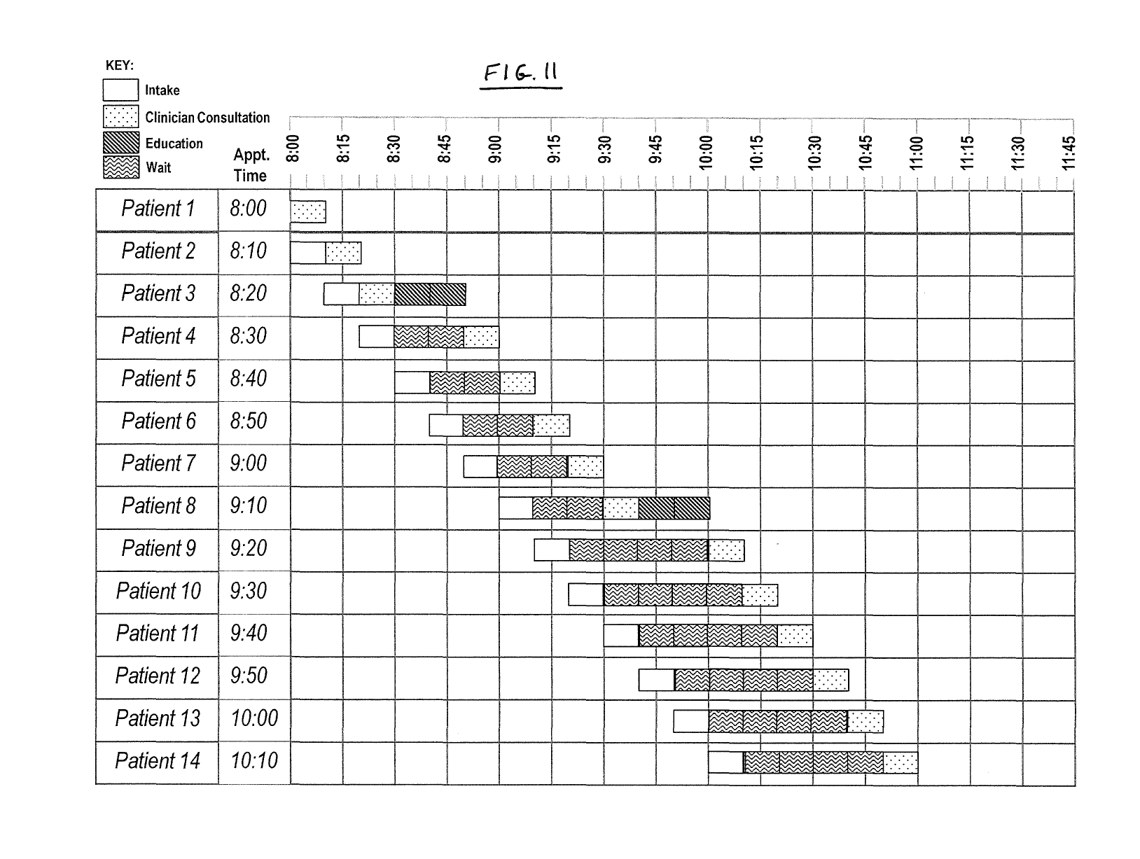

In a prophetic example, scheduling data from an actual practice was run through a simulation. The actual data are shown in FIG. 11. Fourteen patients were seen by a practice during the day of the study. During that day, two patients (shown as Patient 3 and Patient 8) opted for a surgical intervention. For each patient, a time was required for intake, consultation, education, and in most cases a waiting period. Waiting was required when the patient needed to see the clinician, but the clinician was already occupied.

The majority of the patients only needed to briefly consult with the clinician. As can be seen in FIG. 11, the first two patients of the day went through intake and consulted with the clinician without delay. However, Patient 3 needed to be educated regarding a surgical procedure, which required 20 additional minutes of the clinician's attention. Patient 4 was scheduled to consult with the clinician at 8:30, but had to wait an additional 20 minutes to do so, because the clinician was occupied educating Patient 3. Predictably, the 20 minute delay propagated itself across each of the day's remaining patients. This delay was compounded when Patient 8 arrived, and also needed to be educated on a surgical intervention by the clinician; this required another 20 minutes of time, cumulatively causing a 40 minute delay for each of remaining Patients 9-14.

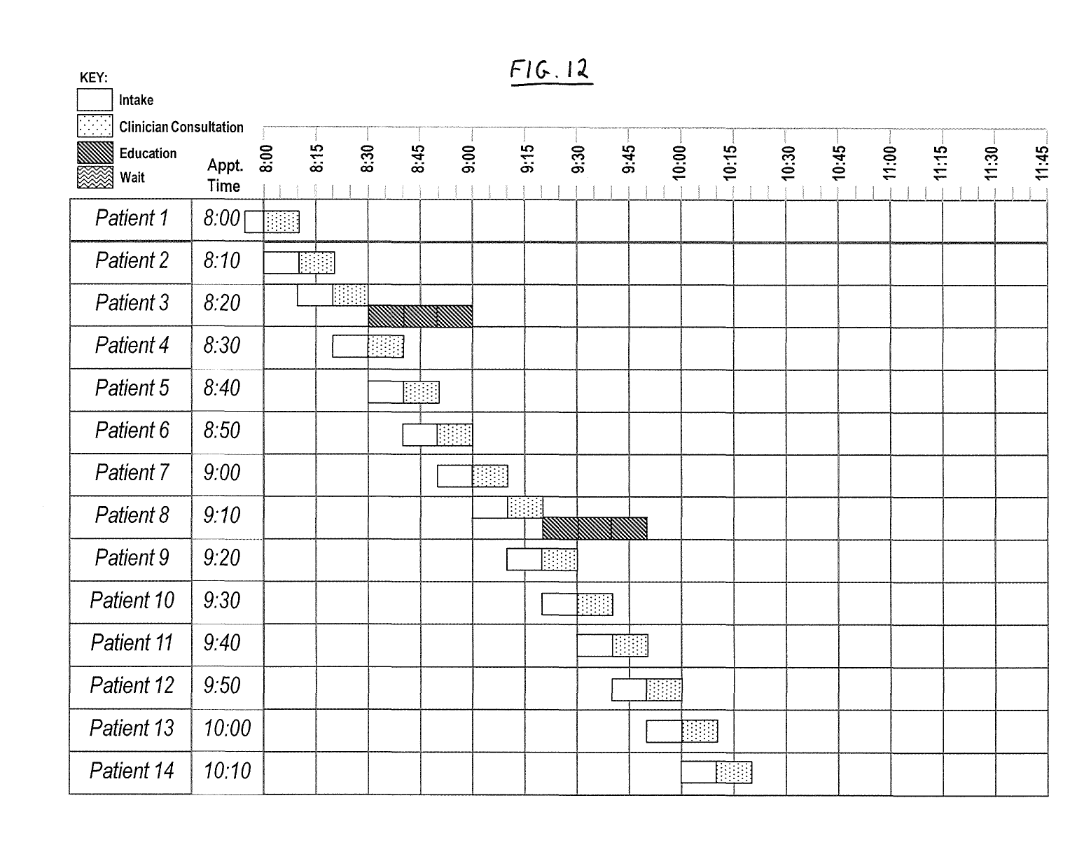

A simulation of the same day is shown in FIG. 12. FIG. 11 shows the same patients, with the same needs, arriving at the same time as in FIG. 11. However, FIG. 12 models the day's schedule if the surgical education had been conducted using an embodiment of the method and system disclosed herein. In the simulation Patients 3 and 8, the local clinician delivers clinical details to the patient about the surgical intervention that only they are qualified to deliver within the originally allotted appointment time. The clinician's staff notifies the remote interviewer in the video call center that a patient is forthcoming. The remote medical interviewer in the video call center brings up the patient's information and the system builds the specific script for the remaining portion of the patient education. The clinician's staff escorts the patient to a designated videoconference location in the local facility to receive the remaining surgical education during a videoconference with a remote medical interviewer. At the conclusion of the videoconference, the remote medical interviewer sends a message to the local clinician's staff that the session is ended as well as any unanswered questions of the patient or important observations about the patient made by the remote interviewer during the videoconference. The patient is given login credentials to watch the recording of their videoconference over the world wide web.

As a result, the local clinician in the simulation was free to attend to the remaining patient consultations as originally scheduled without additional delay. Each patient proceeded directly from intake to consultation. The ultimate outcome was that the needs of 14 patients were attended to in two hours 20 minutes, whereas using onsite education as in FIG. 11, the same required three hours. For a surgical clinician operating 4 clinics per week, this methodology can recover approximately 3 work-weeks of scarce surgical clinician time per year. Additionally, all patients and staff feel less time pressure, lower wait times, and the surgical patient has access to a complete record of their educational interaction.

### E. CONCLUSIONS

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. §1.77 or otherwise to provide organizational queues. These headings shall not limit or characterize the invention(s) set forth herein.

1. A process for providing medical information pertaining to a medical intervention to a patient and documenting comprehension of the information by the patient, the process comprising:
(a) establishing a videoconference between the patient and a medical interviewer;
(b) providing a script to the medical interviewer based on the medical intervention;
(c) transmitting at least a portion of the script to the patient via the videoconference;
(d) transmitting a question to the patient via the videoconference to assess the patient's comprehension; and
(e) creating a machine-readable recording of the patient's response to the question; and
(f) transmitting a patient's unanswered question or condition noted by the medical interviewer to the patient's healthcare provider.

2-4. (canceled)

5. The process of claim 1 comprising creating a first machine-readable recording of the videoconference from a point-of-view of the interviewer; and creating a second machine-readable recording of the videoconference from a point-of-view of the patient.

6. The process of claim 1, comprising transmitting additional information about the intervention to a display visible to the patient during the videoconference, wherein the additional information is in a form selected from the group consisting of: text, graphics, video, and audio-visual.

7. The process of claim 1, comprising transmitting additional information about the intervention to a display visible to the patient during the videoconference, wherein the additional information is in a form selected from the group consisting of: text, graphics, video, and audio-visual; and downloading the additional information to a server that is collocated with the patient prior to establishing the videoconference.

8. (canceled)

9-10. (canceled)

11. The process of claim 1 comprising:
(a) transmitting additional information about the intervention to a display visible to the patient during the videoconference, wherein the additional information is in a form selected from the group consisting of: text, graphics, video, and audio-visual; and
(b) creating a first machine-readable recording of the videoconference from a point-of-view of the interviewer; and creating a second machine-readable recording of the videoconference from a point-of-view of the patient that includes the additional information.

12. The process of claim 1, comprising:
(a) creating a machine-readable recording of the videoconference; and
(b) providing access to the recording of the videoconference to at least one party selected from: the patient, the patient's next-of-kin, legal guardian, and the patient's designee.

13. The process of claim 1, comprising:
(a) providing at least a portion of the patient's health record to the interviewer; and
(b) confirming the applicability of the script in light of the patient's health record.

14. The process of claim 1, comprising generating the script based on the patient's health records.

15. The process of claim 1, comprising generating the script based on the intervention and a datum from the patient's health record, the datum selected from the group consisting of: an allergy, a disability, a contraindicated combination of drugs, a contraindicated combination of drug and procedure, a contraindicated combination of procedures, a genetic risk factor, an existing condition, an existing medication regimen, a prior medication regimen, and a prior condition.

16. The process of claim 1, comprising printing an information document at the patient's location containing at least a portion of the information in the script.

17. The process of claim 1, comprising receiving an affirmation of consent as a digital signature.

18. The process of claim 1, comprising printing an affirmation of consent document at the patient's location.

19. The process of claim 1, comprising:
(a) printing an affirmation of consent document at the patient's location; and
(b) receiving a scanned copy of the signed affirmation of consent document.

20. (canceled)

21. The process of claim 1, comprising:
(a) creating a machine-readable recording of the videoconference; and
(b) providing access via the World Wide Web to the recording of the videoconference to at least one party selected from: the patient, the patient's next-of-kin, legal guardian, and the patient's designee.

22. The process of claim 1, comprising providing access to the recording of the patient's response to a plurality of healthcare providers that have been authorized by the patient.

23. (canceled)

24. The process of claim 1, wherein the interviewer is located in a video call center.

25. (canceled)

26. The process of claim 1, comprising transmitting a nonverbal notification between the interviewer and a healthcare provider collocated with the patient over a telecommunications network, in which the notification is selected from the group consisting of:
the patient's readiness status at the remote location, the interviewer's readiness status at the video call center, a last minute required modification to the script, verification or modification of patient information, a request to summon a medical professional to speak with the patient, an indication that the patient is ready for the intervention, an indication that the patient has unanswered concerns to the intervention, and an indication that the interviewer has observed patient behavior that is of importance to the further processing of the patient by the healthcare provider.

27. The process of claim 1, comprising transmitting a nonverbal notification from the interviewer to a healthcare provider collocated with the patient over a telecommunications network, in which the nonverbal notification is selected from the group consisting of an SMS text message, an electronic mail message, and a real time chat message.

28. A memory storage device composed of non-transient machine-readable media, which when read by a general purpose computing device causes the device to execute the process of claim 1.

29. A process for providing medical information pertaining to a medical intervention to a patient, and documenting comprehension of the information by the patient, the process comprising:
(a) establishing a videoconference between the patient and a medical interviewer;
(b) providing a script to the medical interviewer based on the medical intervention;
(c) transmitting at least a portion of the script to the patient via the videoconference;
(d) transmitting a question to the patient via the videoconference to assess the patient's comprehension;
(e) creating a machine-readable recording of the patient's response to the question;
(f) transmitting a patient's unanswered question or condition noted by the interviewer to the patient's physician;
(g) transmitting a nonverbal notification from the interviewer to a healthcare provider collocated with the patient over a telecommunications network, in which the notification is selected from the group consisting of: the patient's readiness status at the remote location, the interviewer's readiness status at the video call center, a last minute required modification to the script, verification or modification of patient information, a request to summon a medical professional to speak with the patient, an indication that the patient is ready for the intervention, an indication that the patient has unanswered concerns to the intervention, and an indication that the interviewer has observed patient behavior that is of importance to the further processing of the patient by the healthcare provider;
(h) creating a first machine-readable recording of the entire videoconference from a point-of-view of the interviewer;
(i) creating a second machine-readable recording of the entire videoconference from a point-of-view of the patient; and
(j) providing access to the first machine-readable recording of the videoconference to at least one party selected from: the patient, the patient's next-of-kin, legal guardian, and the patient's designee.

30-81. (canceled)
